(19) United States
(12) Patent Application Publication
(10) Pub. No.: US 2026/0065360 A1
(43) Pub. Date: Mar. 5, 2026

(54) SYSTEM AND METHOD FOR PROVIDING REAL-LIFE INTERACTIVE EXPERIENCE BETWEEN VIRTUAL PARTICIPANTS IN A VIRTUAL GATHERING WITHIN A VIRTUAL REAL ESTATE

(71) Applicants: Aniruddha Gupta, Johns Creek, GA (US); Arulita Gupta, Johns Creek, GA (US); Preeti Gupta, Johns Creek, GA (US); Kishor Kumar Gupta, Johns Creek, GA (US)

(72) Inventors: Aniruddha Gupta, Johns Creek, GA (US); Arulita Gupta, Johns Creek, GA (US); Preeti Gupta, Johns Creek, GA (US); Kishor Kumar Gupta, Johns Creek, GA (US)

(21) Appl. No.: 19/315,863

(22) Filed: Sep. 2, 2025

Related U.S. Application Data
(60) Provisional application No. 63/689,847, filed on Sep. 2, 2024.

(51) Int. Cl. G06Q 30/0601; G06Q 10/02; G06Q 30/0645; G06Q 50/00; G06Q 50/16

(52) U.S. Cl. CPC G06Q 30/06433; G06Q 10/02; G06Q 10/40; G06Q 30/0645; G06Q 50/16

(57) ABSTRACT

System and method for virtual office spaces, marketplaces, malls, that realistically mimics working in brick-and-mortar spaces. This innovation allows online shoppers or work from home employees to experience a shared virtual roof similar to a physical environment. In the example of the virtual office, the layout can have individual cabins, open working spaces, cafeteria, lobby, reception, etc. Similar to a physical office, people can freely move around, chat, attend meetings, and collaborate with colleagues/visitors, without disturbing others working in the virtual office. Employees have complete privacy while working in their seat or cabin. Similar to going to a physical office, the employees working from home join virtually, and can see who is present in the office at any given time from the office layout. This innovation removes the barrier of working from home, simulating the physical office environment of spontaneous meetings and collaborations with colleagues, vendors, and customers.

### CROSS-REFERENCE TO RELATED APPLICATION

This application claims priority under 35 USC 119 (e) to U.S. Provisional Patent Application Ser. No. 63/689,847 filed on Sep. 2, 2024 with the Title: “Virtual Real Estate—Real Estate and its experience virtually-Virtual office but close to real-life experience” which is incorporated herein by reference, in its entirety.

### FIELD OF THE INVENTION

The present invention generally relates to virtual interactive communications between individuals through internet platforms. More particularly, the invention relates to a system and method for a real-life interactive experience between virtual participants in a virtual gathering within a virtual real estate.

### BACKGROUND OF THE INVENTION

Working from home is increasingly popular. It provides more flexibility in working hours, and employees save crucial time in getting ready for the office and the commuting time to their workplace. Businesses are also incentivized to encourage work from home practices due to rising real estate prices and the overheads involved in running a brick-and-mortar office space. However, working from home has many drawbacks as well. It may lead to isolation and loneliness due to reduced collaboration and spontaneous communication. It blurs the line between office hours and home time, resulting in a hard-to-manage work-life balance. It can limit employees' visibility and networking, affecting their professional growth and personal well-being. Many businesses are seeing a decline in the office culture and a lack of spontaneous brainstorming and collaboration, resulting in a loss of creativity and innovation. There are many apps/platforms, e.g., Teams, Zoom, WebEx, Google Meet, where people can video chat individually with each other or in a group. These platforms are used for meetings, webinars, conferences, and discussions. These platforms have features like a whiteboard, breakout rooms, town hall meetings, and conferences. While these platforms fulfill some needs, they miss the real-life experience, which is crucial for both employees and employers, and the growth of the businesses. There are many studies that see the impact of long-term work from home on the mental and physical health of employees. Many businesses are not satisfied with the work-from-home situation, but due to added real estate costs and employees' resistance, they are hesitant to enforce an in-person work policy. There is a dire need for a virtual office that can provide an in-person experience to Work From Home (WFH) employees and answer the concerns of businesses as well, giving a win-win situation for both the employer and the employees. Similarly, studies show that customers increasingly avoid going to the physical shopping mall due to their busy lifestyle and post pandemic shopping culture. There are certain benefits of online shopping. Buyers save time and money from commuting to the stores or mall, and the businesses save on the high cost of running a brick-and-mortar store, which is especially crucial for small business owners. However, online buying and selling have many drawbacks, too. In the case of online shopping, information about the product is limited to what is posted on the website, but buyers may have additional questions. This can cause buyer dissatisfaction if the product needs are not met and the product is returned. This causes loss of time, money, resources, and buyers' trust. In online shopping, people do not get the same satisfaction as they receive while shopping in a retail store or in the mall. There is a dire need for an online platform that can provide an online shopping experience similar to shopping in-person in a brick-and-mortar shop, benefiting the businesses and the customers.

The present invention provides a sustainable solution through virtual real estate in which virtual participants will have a close to in-person experience. In the system and method of the present invention, participants in a virtual office, virtual mall, or virtual marketplace experience close to real-life interactions with other participants in a virtual office, mall, or marketplace. The exemplary features of the present invention will become obvious to one skilled in the art through the summary of the invention, the detailed description of the invention, and the claims that follow.

### SUMMARY OF THE INVENTION

The present invention relates to a system and method for enabling real-life interactive experiences among virtual participants, also known as online participants, in a virtual gathering within a virtual real estate, including offices, shops, showrooms, markets, malls, and similar types of spaces. The tenants who rent the virtual premises in virtual real estate either choose their office, shops, similar space layout from the existing layout or provide a layout. These layouts may further incorporate cabins, tables, chairs, and other forms of furniture for participant seating, as well as functional spaces such as cafeterias, conference rooms, networking lounges, relaxation areas, or gyms. The arrangement of these spaces is designed to simulate real-life environments where both formal and informal gatherings can take place.

In the exemplary embodiment of the platform of the present invention, the tenants reserve the seating place like a cabin, a table for some participants, including employees; whereas participants, including buyers, visitors, and guests, may not have reserved a seat. On the layout, areas are marked, and on clicking, participants can enter the space, like a cabin mark with a person's name. If participants click on the person's name, they will enter the cabin after permission is granted. Participants from some kind of indication, including a change in name color on the cabin will be able to know if the cabin owner is inside or not. Participants access the tenant's premises through computers or mobile devices and are represented within the virtual layout by means of a graphical user interface. Within this environment, participants are able to see, hear, and interact with others seated at the same cabin or piece of furniture, thereby creating an experience of local presence. At the same time, the invention provides privacy, since participants seated in different cabins or furniture cannot hear or see one another. The tenant may further control the mode of interaction, enabling participants to switch between a local mode, limited to those seated together, and a global mode, in which all participants of the virtual gathering are able to interact. If the participant is sitting alone in a space like a cabin, no one can hear or see the participant, even if the participant's video is on.

In the exemplary embodiment of the platform of the present invention, in addition to privacy and interaction controls, the invention provides flexibility in movement and engagement. Participants may move between cabins, join groups, or mingle in crowd-like settings, thereby replicating the spontaneous interactions of physical gatherings. Reserved and unreserved seating options to function as exclusive private spaces, accessible only with permission of the owner, while unreserved spaces remain freely available. This structure allows both open and restricted participation within the same premises.

In the exemplary embodiment of the platform of the present invention, the invention also supports media interaction, including local and global modes of screen sharing and streaming. A participant may share content privately with those seated at the same cabin or extend it to all participants, depending on the interaction setting. The tenant may also record the gathering, allowing participants to replay the event on demand, thereby extending the usefulness of the system for training, presentations, or entertainment purposes. Another feature of the invention is multi-tenant scalability. A plurality of tenants, each operating their own premises, may combine their environments so that participants can interact as though they were present in a single integrated premises. This feature allows gatherings to scale across multiple tenants while preserving the cabin-based privacy and interaction rules that are central to the invention.

In the exemplary embodiment of the platform of the present invention, through the combination of configurable layouts, controlled privacy, reserved and unreserved seating, flexible media sharing, and multi-tenant expansion, the invention provides a virtual real estate that mirrors real-life experiences in both professional and social contexts. It allows participants to engage in structured discussions, informal networking, and leisure activities in a manner that feels natural and immersive, while maintaining the necessary boundaries of privacy and control. In doing so, it addresses the limitations of conventional online meeting platforms by introducing spatial, privacy-aware, and multi-environment interaction models that more closely replicate real-world gatherings.

In one exemplary embodiment of the system and method of the invention, the customer, also known as a tenant, creates a visualized office layout as needed using a premade layout provided by the platform or a picture-based, hand-drawn, or digitally designed layout using digital tools. The size of this virtual office/facility depends on the number of people in the office or the customer's needs. The design may include elements such as offices, cubicles, cafeteria, common room, conference room, and front desk. All these spaces are labeled and clickable. If someone clicks on a space they have access to, they will enter the space. Each space will have a seating arrangement, depending on the customer's needs.

In one exemplary embodiment of the system and method of the invention, virtual participants see a bird's-eye view of the office with front desks, cabins, cubicles, conference rooms, cafeteria, networking lounge, relaxation area, or gyms, depending on the customer's needs. The physical office has employees who have reserved space. Visitors such as buyers, vendors, and guests may not have reserved space in the office. In the physical office, employees can move around. To emulate the physical office, in a virtual office, people can knock on anyone's door by clicking on their name, and the cabin owner may allow the person to come in. In a physical office, employees can see if a person is in their office or in a meeting. Similarly, in a virtual office, employees can see if a person is in their office or in a meeting with someone else. In the virtual office, employees can use the layout to move around, sit at a designated place or anywhere as per the customer settings, and see and talk to the other employees around them. Office employees are free to move to an unreserved space with permission. However, visitors will need permission to move around and may be guided by the front desk depending on the customer's restrictions.

In one exemplary embodiment of the system and method of the invention, if an employee is sitting alone, they have privacy, No one can hear or see that person, even if audio and video are on. In case of a presentation streamed to the entire office, the office layout may be replaced by the presentation. The office layout will be available in the corner of the screen. In case of a team meeting, presentations can be done in a conference room, cubicle, or a person's seat. People should be able to share their screen or stream from any device. This invention has notifications, e.g., alerts if the office is closed and a visitor is trying to enter. Since employees are now working from home, they may not have a business card with an address. With a virtual office, one can have a business card with a virtual office address and office hours.

In one exemplary embodiment of the system and method of the invention, here is a possible scenario of an employee going to the office. Virtual office hours are 8 AM to 5 PM. Employee gets up in the morning and is ready for the virtual office. At 8 AM, employees click on the office link. A landing page with an office building pops-up, showing the company name on the building. Employees click on the Join Office tab, and after logging in, employees enter their reserved cubicle/cabin. Employees see the cabin on the right side of the screen and the office layout showing who is in the office on the left side. Green and red dots show who is in the office. Employees can send a message to a coworker on an 1:1 chat. Employees can also send a message to the whole office using the global chat. Using the office layout, an employee can see a couple of people in the virtual common area. The employee can go to the virtual common area to greet coworkers before coming back to their own cubicle/cabin. In one exemplary embodiment of the system and method of the invention, After some time, the employee hears a knock, and a notification pops up with a request to join. The employee allows that person to join a video chat. Both discuss the project and share their screens. In another cabin, the manager tells the secretary he wants to have an urgent meeting with the team in one hour. Everyone gathers in the virtual meeting room. From the layout, people can see the manager and others leaving the cabin and joining the meeting room. After the meeting, everyone goes back to their cabin. An unexpected vendor comes to the front desk. The person at the front desk guides the vendor to the cabin of the employee responsible for purchasing. Similarly, a client comes to see the manager. The manager and client meet in the conference room. The manager sends a chat message to an employee, and that employee joins the meeting with the client and vendor. During lunchtime, some people join the virtual cafeteria and have lunch together and chat. This company has many virtual offices in many countries, and today the CEO of the company is scheduled to address all of the employees of the company. The CEO is addressing employees. Some employees are watching the CEO's address by themselves, and others are in's conference room and watching together. Since some employees are sitting together, they can have a discussion on the CEO's address without disturbing anyone not in their conference room. Now it is tea time, employees are having a break sitting in groups in the cafeteria or at a common place, and are having tea and chatting. After tea, everyone goes back to their reserved cabin. Tomorrow is a busy day. The company is launching a new product virtually using this office platform, and all our clients are virtually invited. Everyone is moving into the conference room for planning the product launch. After the meeting, everyone disperses. After a hour of work employees calls it a day and leave the virtual office.

In one exemplary embodiment of the system and method of the virtual real estate invention can be a virtual mall for online shopping. Unlike present online shopping platforms, where the shoppers depend solely on the pictures and specifications of the products posted on websites, the invention allows sellers to showcase their products in great detail to ensure customer satisfaction. The customer can ask questions about the product, just like shopping in person, which will help in making informed purchases. This will help reduce the return of the online purchases, save shipping costs, avoid waste, save packing materials and the environment, and result in greater business profits. This innovation will go beyond the physical shopping experience in a brick-and-mortar store, as customers can shop together with friends and family, geographically located in different parts of the world. For example, a buyer may ask their family member or friend to go to the virtual mall with them to shop for wedding outfits, an engagement ring, or gifts for special occasions. This innovative platform breaks the physical barrier and provides friends and family the opportunity to join virtually from any location for a fun shopping experience.

In one exemplary embodiment of the system and method of the invention, virtual real estate can be a virtual marketplace for selling goods. An example of this can be a car marketplace for used and new cars. The unique feature of the invention will facilitate the buyers to visit the market place virtually, talk to the vendors selling their cars for detailed specifications, move freely from one vendor to other and decide on making a purchase. In a short period of time, buyers can find the car they like from the comfort of their home. This will also avoid online scams. At the same marketplace, other services like car history check, loan, and similar services can also be provided. Once the car sale is finalized, a car and money transfer facility can also be provided for a fee.

### BRIEF DESCRIPTION OF THE DRAWINGS

The present invention is illustrated by way of examples, and not by way of limitations, in the figures of the accompanying drawings in which:

FIG. 1 is a diagram illustrating an example of virtual real estate, i.e., building, office, mall, shopping center, and market.

FIG. 2 is a diagram illustrating an example of a bird's-eye view of a virtual real estate floor layout, showing offices, shops.

FIG. 3 is a diagram illustrating an example of a bird's-eye view office layout.

FIG. 4 is a functional diagram illustrating an example of a typical view of the participant's screen after joining an office through the system platform.

FIG. 5 is a block diagram of an exemplary illustration of the system architecture.

### DETAILED DESCRIPTION OF THE INVENTION

The present invention is a system and method for real-life interactions between online participants, also known as virtual participants, in a virtual office, virtual mall, virtual market or virtual shopping center experience. The platform of the invention gives online participants in a gathering an opportunity to have one-on-one or group interactions with other online participants in a gathering. The system of the invention uses standard conferencing technology and equipment for facilitating close to real-life virtual interactions between the participants in a gathering.

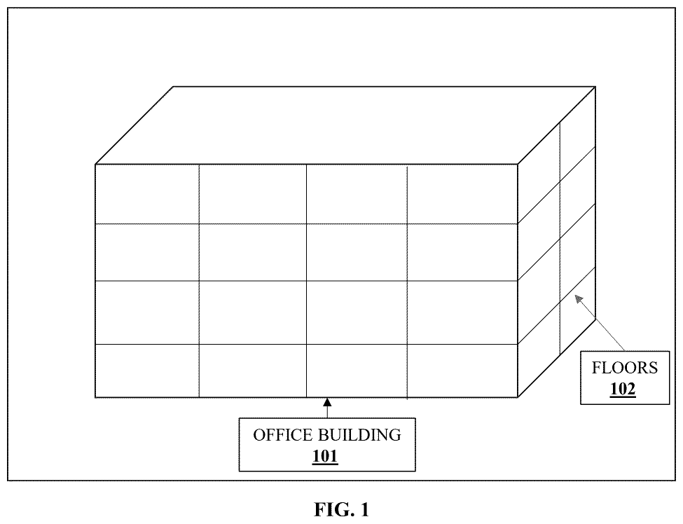

Referring now to the drawings wherein like numerals represent like components, FIG. 1 is a diagram illustrating an example of a typical building of office, mall, shopping center, market, and similar types of spaces 101. This virtual building can have any number of floors, from a single-floor 102 to a multi-floor building. This virtual building can have offices of many organizations/companies or only one organization/company. In the case of a virtual office, this type of office building could be the virtual participants' typical landing page to view on their screen. Office owners, shopkeepers, and sellers rent virtual space in this building. If someone does not want a space in the building, they can also rent standalone virtual real estate. Virtual space is available in all sizes to handle small gatherings to hundreds of thousands of participants. Customer can provide design their own building or choose from the available ones.

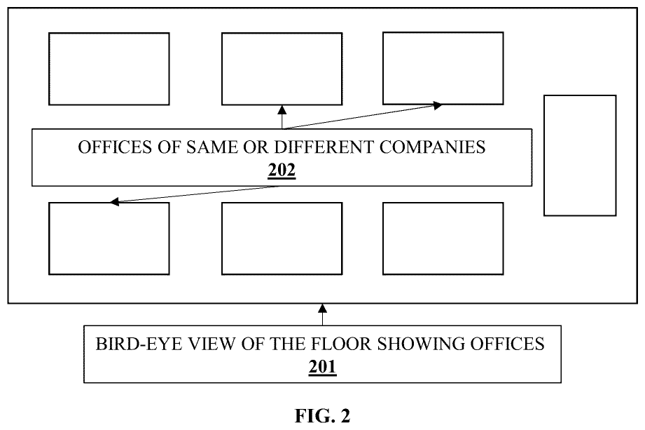

FIG. 2 is also a block diagram of an exemplary embodiment of the invention, illustrating an example of an office building floor layout. The layout shows a bird's-eye view 201 of the floor, showing different offices. These offices may be owned by the same company or a different company 202. Customer can design their own layout or choose from the available layouts. These layouts could be designed using a picture, hand-drawn, or created using digital tools. In the case of a weekly market, just this type of floor layout without a building may be sufficient. Real layout picture can also be used for layouts.

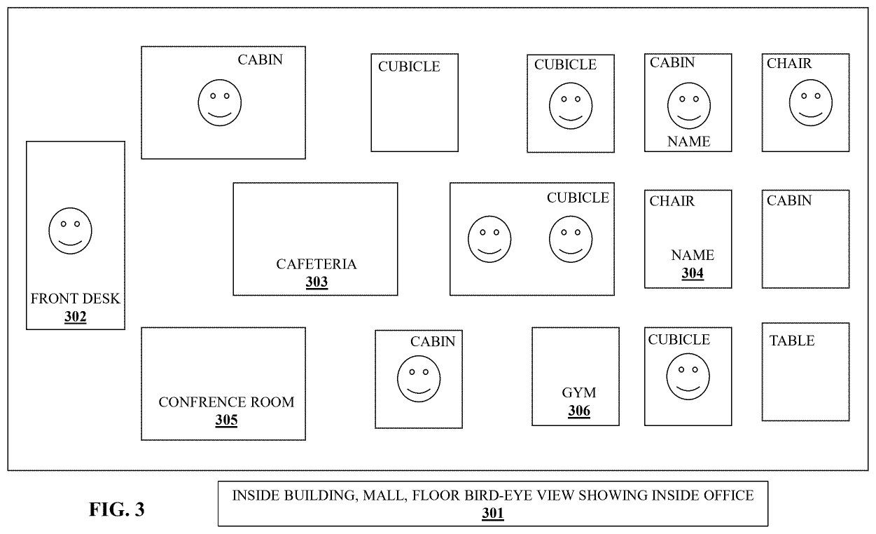

FIG. 3 is a block diagram of an exemplary embodiment of the invention, illustrating an example of an office layout. Similar layouts can be made for shops, etc. The layout shows a bird's-eye view 301 of the office layout from inside. Since this is an example of an office, there are cubicles, cabins, chairs 304, tables, cafeteria 303, conference room 305, and front desk 302. In real life employees may have reserved space 304 to sit in cabins, cubicles, or chairs, and they come in the morning and go straight to their desks. In a virtual office, they too would start at their reserved sitting location. Online participants of the virtual office will be able to reserve virtual cabins, cubicle, and chair for themselves or for team meetings. Employees who have a reserved seat may also have their name 304 shown on their virtual chair, cubicle, or cabin. If employees are in the office, participants from the employee's name, picture, or color change on their sitting place e.g., cabin can know about it and are free to click on their icon to ask permission to enter their virtual sitting place, e.g., cabin. Even if an employee in the virtual office has their audio/video on, they have total privacy if they are sitting in their cabin alone. No one is able to hear or see them. If they are virtually sitting with other online employees/guests in a cubicle, chair, or cabin, only those guests can see and hear them; no one else in the office can. Coworkers can see who is in the office and if they are available to chat or not. Employees can move anywhere in the virtual office. If they want to talk to a coworker, they can virtually knock on the door and request to be let into their coworkers virtual cabin, cubicle, or chair. For employee's health, there can be places like a virtual cafeteria 303 where employees can take a break, e.g., virtually sit and have lunch together. Employees can take a break for gym 306 and virtually work out together or simply indicate that they are unavailable until they get back form the gym. For virtual meetings, etc., there can be a conference room 305. Each cabin, chair, table, cubicle and additional furniture has seats inside it to host guests. In physical offices, we host visitors, buyers, sellers, and guests, and sometimes they come without prior appointments. In the virtual office, there is a front desk 302, and from here they are guided to the desired place in the office. In the example of virtual shops instead of virtual offices, buyers can be directed to the where the salesperson can help the buyer.

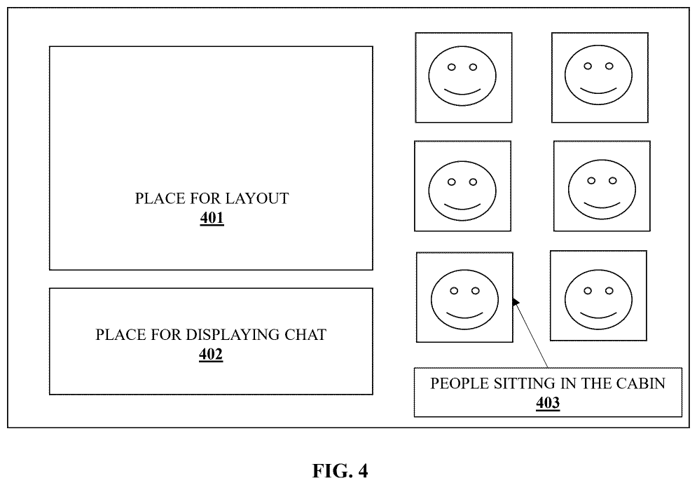

FIG. 4 is a block diagram of an exemplary embodiment of the invention, illustrating an example of a typical view of the participant's screen after joining an office through the system platform. Each cabin, chair, table, cubicle, and additional furniture has seats inside it so that participants can host guests. In this picture, the employee is hosting five guests 403. Participants see the office layout in the area place for layout 401. Participants can see who is in the office, sitting at their seat or with someone else, they just click on the name of the person they want to meet and move to their cabin. In the area, a place for layout participants can also see when they share the screen or stream anything. In the chat box area, 402 participants can see one-on-one chat, group chat, and global chat.

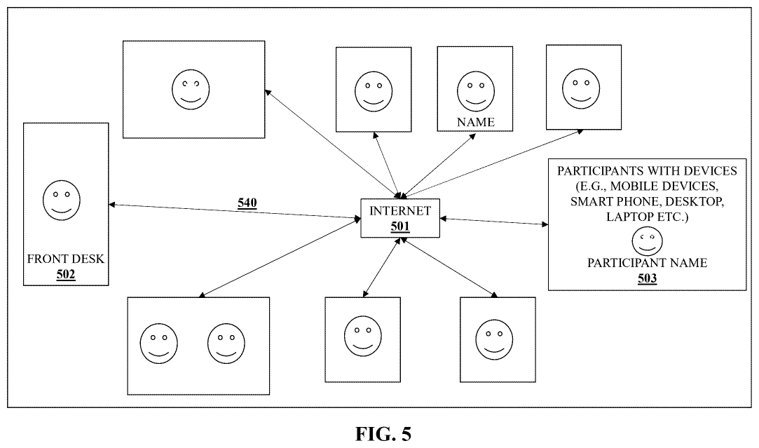

FIG. 5 is a block diagram of an exemplary illustration of the system architecture for an office scenario in which participants join the event virtually using the platform of the invention. In this office, there are virtual cabins, tables, and seats for the participants to sit at, and the participants can move from one cabin or table to another cabin or table. Participants join the event through their desktops, mobile devices such as smartphones, laptops, tablets, etc., and virtually sit in a cabin or table. Through the internet 501, participants 502, 503 communicate 504 with each other and move from one cabin to another. The system of the invention uses standard conferencing technology and equipment for facilitating virtual interactions between the participants in a gathering.

The foregoing description of the system and method of the present invention through its figures and preferred embodiment(s) should not be construed to limit the scope of the invention. It is to be understood that the embodiment(s) of the invention as described herein do not limit any application or scope of the invention and that the invention can be carried out and practiced in various ways and implemented in embodiments other than the ones outlined in the summary and detailed description of the working and application of the system. It should be understood and obvious to one skilled in the art that alternatives, modifications, and variations of the embodiments of the present invention as described may be construed to be within the spirit and scope of the appended claims.

What is claimed is:

1. A method for providing real-life interactive experience between virtual participants in a virtual gathering within a virtual real estate, the method comprising:
a) a virtual real estate comprising at least one type of space selected from the group consisting of offices, shops, showrooms, markets, buildings, malls, and combinations thereof, and further including one or more additional types of spaces;
b) a virtual real estate online platform enabling tenants to rent the virtual real estate within the virtual real estate;
c) said virtual real estate comprising one or more tenants;
d) said tenant renting one or more virtual real estates, in part or the full;
e) said tenant's virtual premises use comprising at least one type of space selected from the group consisting of offices, shops, showrooms, markets and combinations thereof, and further including one or more additional types of spaces;
f) said virtual real estate comprising a virtual real estate layout;
g) said tenant providing a layout of said tenant's virtual premises for said plurality of virtual participants to view;
h) said layout comprising a premade layout, a layout made from available tools, a picture-based layout, a hand-drawn layout, a digitally created layout or combinations thereof;
i) said layout comprising offices, shops, showrooms, and additional types of spaces for said plurality of virtual participants to sit while viewing, listening, and talking to other virtual participants;
j) said layout further comprises cabins, boxes, tables, chairs, and additional furniture for said plurality of virtual participants to sit while viewing, talking and listening to other virtual participants in said tenant's virtual premises; and wherein, said cabins, boxes, tables, chairs, and additional furniture in said tenant's virtual premises provide seating arrangements for said plurality of virtual participants;
k) said plurality of virtual participants, also known as online participants comprising employees, buyers, sellers, customers, vendors, guests, and additional classes of participants;
l) said virtual participants accessing said tenant's virtual premises on computers and mobile devices to view said tenant's premises layout for a virtual commerce experience of offices, shops, showrooms, markets and additional types of spaces;
m) said plurality of virtual participants viewing the virtual presence of all other participants at said tenant's virtual premises and seeing said participants seated on the layout through a graphical user interface (GUI) on their computers, and mobile devices;
n) said plurality of virtual participants being able to see video and hear audio of other virtual participants seated at the same cabin, box, table, and said additional furniture;
o) said virtual participants in said tenant's virtual premises being seated in cabins or furniture, wherein said participants can hear and see only the other participants seated in the same cabin or furniture, and cannot hear or see participants seated in other cabins or furniture within same virtual premises;
p) said plurality of virtual participants joining other virtual participants in said virtual premises and virtually interacting with each other at the virtual gathering;
q) said virtual interactions between said plurality of virtual participants at the virtual gathering of said virtual premises comprising, said participants moving to sit at other cabins or additional furniture to interact with other virtual participants seated there;
r) said virtual participants mingling and moving virtually in a crowd gathered in said virtual premise, stopping to meet other virtual participants around them while viewing the gathering;
s) said virtual interactions between said plurality of virtual participants at the virtual gathering of said virtual premises comprising participants sitting at a cabin or other furniture next to other participants and chatting via video and audio and chat boxes, wherein said chat boxes are local chat boxes for said virtual participants seated at the same cabin or furniture and global chat boxes for all said participants of said premises;
t) said virtual participants sending messages to specific virtual participants by tagging them through said chat boxes;
u) said virtual interactions between said plurality of virtual participants at the virtual gathering of said virtual premises comprising participants sitting at a cabin or other furniture next to other participants and streaming or sharing screen with them, wherein said streaming and screen sharing are local for participants seated at the same cabin or furniture and global for all participants of the tenant premises;
v) said tenant being able to record the meeting, and said plurality of virtual participants being able to watch the recording on demand;
w) said plurality of virtual participants comprising participants with reserved cabin or additional furniture in said tenant's virtual premises, and participants with unreserved cabin or additional furniture in said tenant's virtual premises;
x) said plurality of virtual participants being free to move around like walking in an office and to sit at designated places according to the tenant's settings, and wherever they sit, they join the cabin or furniture where they are seated and interact with the participants around them, wherein participants with reserved cabin or furniture in said tenant's virtual premises have designated places to sit, may move on unreserved cabin or furniture freely, and may move to reserved cabin or furniture with permission from the owner; and wherein, other virtual participants required permission to move around and join other participants' cabin depending on tenant restrictions;
y) said plurality of virtual participants on said tenant's virtual premises in one or more virtual real estate globally being able to interact with participants in one or more other virtual premises of said host, equivalent to one combined premises;
z) said virtual real estate comprising one or more tenants, and said plurality of participants being able to move around from one tenant's premises to another tenant's premises; and
aa) wherein said plurality of virtual participants of said virtual gathering of said virtual premises through said virtual interactions with said plurality of other virtual participants of said virtual premises have a real-life interactive experience with said plurality of virtual participants of said virtual premises.

2. The method of claim 1, wherein said reserved cabins or furniture provide exclusive private spaces accessible only with permission of the owner.

3. The method of claim 1, wherein said plurality of virtual participants seated in one cabin or furniture have audio and video privacy such that participants in other cabins or furniture cannot hear or see them.

4. The method of claim 1, wherein said virtual participants are able to see and hear only participants seated at the same cabin or furniture.

5. The method of claim 1, wherein said tenant provides a privacy control to switch between a local interaction mode (private to the same cabin) and a global interaction mode (open to all participants).

6. The method of claim 1, wherein said virtual layout within said tenant's virtual premises comprises spaces selected from the group consisting of a cafeteria, a conference room, a meeting room, a networking lounge, a relaxation space, a gym, or combinations thereof.

7. The method of claim 1, wherein said plurality of virtual participants interact within said cafeteria space for informal or casual discussions.

8. The method of claim 1, wherein said plurality of virtual participants interact within said conference or meeting space for presentations, talks, or formal discussions.

9. The method of claim 1, wherein said plurality of virtual participants interact within said gym or relaxation space for non-work activities while remaining virtually present in said premises.

10. The method of claim 1, wherein said plurality of virtual participants across multiple virtual premises of one or more tenant interact as if in one combined virtual premises while maintaining cabin-based privacy rules.

11. A system for providing real-life interactive experience between virtual participants in a virtual gathering within a virtual real estate, said system comprising:
a) a virtual real estate comprising at least one type of space selected from the group consisting of offices, shops, showrooms, markets, buildings, malls, and combinations thereof, and further including one or more additional types of spaces;
b) a virtual real estate online platform enabling tenants to rent the virtual real estate within the virtual real estate;
c) said virtual real estate comprising one or more tenants;
d) said tenant renting one or more virtual real estates, in part or the full;
e) said tenant's virtual premises use comprising at least one type of space selected from the group consisting of offices, shops, showrooms, markets and combinations thereof, and further including one or more additional types of spaces;
f) said virtual real estate comprising a virtual real estate layout;
g) said tenant providing a layout of said tenant's virtual premises for said plurality of virtual participants to view;
h) said layout comprising a premade layout, a layout made from available tools, a picture-based layout, a hand-drawn layout, a digitally created layout or combinations thereof;
i) said layout comprising offices, shops, showrooms, and additional types of spaces for said plurality of virtual participants to sit while viewing, listening, and talking to other virtual participants;
j) said layout further comprises cabins, boxes, tables, chairs, and additional furniture for said plurality of virtual participants to sit while viewing, talking and listening to other virtual participants in said tenant's virtual premises; and wherein, said cabins, boxes, tables, chairs, and additional furniture in said tenant's virtual premises provide seating arrangements for said plurality of virtual participants;
k) said plurality of virtual participants, also known as online participants comprising employees, buyers, sellers, customers, vendors, guests, and additional classes of participants;
l) said virtual participants accessing said tenant's virtual premises on computers and mobile devices to view said tenant's premises layout for a virtual commerce experience of offices, shops, showrooms, markets and additional types of spaces;
m) said plurality of virtual participants viewing the virtual presence of all other participants at said tenant's virtual premises and seeing said participants seated on the layout through a graphical user interface (GUI) on their computers, and mobile devices;
n) said plurality of virtual participants being able to see video and hear audio of other virtual participants seated at the same cabin, box, table, and said additional furniture;
o) said virtual participants in said tenant's virtual premises being seated in cabins or furniture, wherein said participants can hear and see only the other participants seated in the same cabin or furniture, and cannot hear or see participants seated in other cabins or furniture within same virtual premises;
p) said plurality of virtual participants joining other virtual participants in said virtual premises and virtually interacting with each other at the virtual gathering;
q) said virtual interactions between said plurality of virtual participants at the virtual gathering of said virtual premises comprising, said participants moving to sit at other cabins or additional furniture to interact with other virtual participants seated there;
r) said virtual participants mingling and moving virtually in a crowd gathered in said virtual premise, stopping to meet other virtual participants around them while viewing the gathering;
s) said virtual interactions between said plurality of virtual participants at the virtual gathering of said virtual premises comprising participants sitting at a cabin or other furniture next to other participants and chatting via video and audio and chat boxes, wherein said chat boxes are local chat boxes for said virtual participants seated at the same cabin or furniture and global chat boxes for all said participants of said premises;
t) said virtual participants sending messages to specific virtual participants by tagging them through said chat boxes;
u) said virtual interactions between said plurality of virtual participants at the virtual gathering of said virtual premises comprising participants sitting at a cabin or other furniture next to other participants and streaming or sharing screen with them, wherein said streaming and screen sharing are local for participants seated at the same cabin or furniture and global for all participants of the tenant premises;
v) said tenant being able to record the meeting, and said plurality of virtual participants being able to watch the recording on demand;
w) said plurality of virtual participants comprising participants with reserved cabin or additional furniture in said tenant's virtual premises, and participants with unreserved cabin or additional furniture in said tenant's virtual premises;
x) said plurality of virtual participants being free to move around like walking in an office and to sit at designated places according to the tenant's settings, and wherever they sit, they join the cabin or furniture where they are seated and interact with the participants around them, wherein participants with reserved cabin or furniture in said tenant's virtual premises have designated places to sit, may move on unreserved cabin or furniture freely, and may move to reserved cabin or furniture with permission from the owner; and wherein, other virtual participants required permission to move around and join other participants' cabin depending on tenant restrictions;
y) said plurality of virtual participants on said tenant's virtual premises in one or more virtual real estate globally being able to interact with participants in one or more other virtual premises of said host, equivalent to one combined premises;
z) said virtual real estate comprising one or more tenants, and said plurality of participants being able to move around from one tenant's premises to another tenant's premises; and
aa) wherein said plurality of virtual participants of said virtual gathering of said virtual premises through said virtual interactions with said plurality of other virtual participants of said virtual premises have a real-life interactive experience with said plurality of virtual participants of said virtual premises.

12. The system of claim 11, wherein said reserved cabins or furniture provide exclusive private spaces accessible only with permission of the owner.

13. The system of claim 11, wherein said plurality of virtual participants seated in one cabin or furniture have audio and video privacy such that participants in other cabins or furniture cannot hear or see them.

14. The system of claim 11, wherein said virtual participants are able to see and hear only participants seated at the same cabin or furniture.

15. The system of claim 11, wherein said tenant provides a privacy control to switch between a local interaction mode (private to the same cabin) and a global interaction mode (open to all participants).

16. The system of claim 11, wherein said virtual layout within said tenant's virtual premises comprises spaces selected from the group consisting of a cafeteria, a conference room, a meeting room, a networking lounge, a relaxation space, a gym, or combinations thereof.

17. The system of claim 11, wherein said plurality of virtual participants interact within said cafeteria space for informal or casual discussions.

18. The system of claim 11, wherein said plurality of virtual participants interact within said conference or meeting space for presentations, talks, or formal discussions.

19. The system of claim 11, wherein said plurality of virtual participants interact within said gym or relaxation space for non-work activities while remaining virtually present in said premises.

20. The system of claim 11, wherein said plurality of virtual participants across multiple virtual premises of one or more tenant interact as if in one combined virtual premises while maintaining cabin-based privacy rules.
